(19) United States
(12) Patent Application Publication
(10) Pub. No.: US 2020/0286215 A1
(43) Pub. Date: Sep. 10, 2020

(54) SYSTEMS AND METHOD FOR REMOTE DETECTION AND PREDICTION OF TANK CORROSION

(71) Applicant: AWIP Holdings LLC, Camden, NJ (US)

(72) Inventors: Jeffrey Brill, Wallingford, PA (US); Christopher Kahn, Somerdale, NJ (US)

(21) Appl. No.: 16/295,017

(22) Filed: Mar. 7, 2019

(51) Int. Cl. G06T 7/00

(52) U.S. Cl. CPC G06T 7/001; G06T 2207/20021; G06T 2207/30136; G06T 2207/30184; G06T 2207/20081; G06T 2207/10032

(57) ABSTRACT

A system and method includes a processor, an input/output interface connected to the processor and memory coupled to the processor, the memory storing executable instructions that cause the processor to effectuate operations including collecting, by the processor, surface images of an object captured by a camera, storing, by the processor, the captured surface images in a historical database comprising previous images of the object, dividing, by the processor, the captured surface images into one or more sectors, identifying, by the processor, a defect in the one or more sectors of the captured surface image, analyzing, by the processor, the defect in the one or more sectors of the captured surface images in view of the previous images, predicting, by the processor, future defects based on the analyzing step.

### TECHNICAL FIELD

The disclosure is directed to a system and method for efficiently inspecting tanks, and more specifically, to a remote inspection system using unmanned aerial vehicles coupled with machine learning computer systems to inspect tanks and detect corrosion and other defects and proactively manage maintenance thereof.

### BACKGROUND

Water tanks are relied upon across a range of industries. Whether for industrial applications or personal use, it is important that the central water supply remains clean and safe. The water quality is dependent in large part on the condition of the water tanks in which it is stored. To maintain optimum tank conditions, inspections both inside and outside the tank are required.

Currently, the most common way to perform interior inspections is to completely drain the tank and arrange for personnel to perform close-up inspections, which presents a confined space hazard. Tanks are then cleaned or treated if necessary, then re-filled. This method can take the tank offline for up to three days, or longer if remedial treatment is required. Another method is to use remotely operated vehicles deployed within the water tank to photograph and test and, if necessary, treat the water. Yet another method is to employ certified divers to enter the tanks.

External inspections are currently limited to visual inspections for chipping, corrosion, rust or any other external conditions that may affect the integrity of the tank structure or the quality of the water within the tank. Such visual inspections are currently performed by personnel climbing the water tanks or from aerial surveillance of the tanks. Such visual external inspections continue to be labor intensive.

There exists a need for creating and deploying a fully-functional and more efficient system for identifying rust and other defects or wear on above ground storage tanks.

### SUMMARY

The present disclosure is directed to a system including a processor, an input/output interface connected to the processor; and memory coupled to the processor, the memory storing executable instructions that cause the processor to effectuate operations including collecting, by the processor, surface images of an object captured by a camera, storing, by the processor, the captured surface images in a historical database comprising previous images of the object, dividing, by the processor, the captured surface images into one or more sectors, identifying, by the processor, a defect in the one or more sectors of the captured surface image, analyzing, by the processor, the defect in the one or more sectors of the captured surface images in view of the previous images, and predicting, by the processor, future defects based on the analyzing step. In an aspect, analyzing step includes determining the percentage of defects in the object relative to a total surface area of the object. The percentage of defects is extrapolated by an amount of a defect identified in the in one or more sectors. The operations may further include scheduling remedial actions based on the predicting step and may include correlating, by the processor, the one or more sectors of the captured images with corresponding sectors of the previous images and the analyzing step analyzes the one or more sectors in view of the correlating sectors. In an aspect, the historical database may also include images and metadata of a plurality of other similar objects and wherein the operations further include creating a model using the plurality of other similar objects and wherein the analyzing step analyzes the captured surface images in view of the model. The camera may be mounted on an unmanned aerial vehicle (UAV) and in the object is a tank which may, for example, be one of a water tank, a fuel tank and a chemical feed tank. The camera may be mounted on an unmanned aerial vehicle and the object is a water tank. In an aspect, the historical database also includes images and metadata of a plurality of other water tanks and wherein the operations further include creating a model using the plurality of other water tanks and wherein the analyzing step analyzes the captured surface images in view of the model. In an aspect, the analyzing step includes generating a prediction based on a machine learning algorithm.

The disclosure is also directed to a system including an input port configured to receive current image files and metadata from a camera, a database connected to the input port for storing the current image files and metadata, the database also containing historical image files and metadata, an application server connected to the database through an application programming interface, wherein the application server is configured to process the current image files and metadata by dividing an image into one or more of sectors, identifying a defect in the one or more sectors, analyzing the defect in the one or more sectors of the historical image files and predicting future defects based on the analyze step. The historical image files may also be divided into sectors corresponding to the one more sectors. In an aspect, the analyzing step calculates a percentage of the defect in the one or more sectors to estimate a total percentage of defects for an object and wherein the object may be a tank. In an aspect, the may be mounted on an unmanned aerial vehicle and the predicting step includes generating a prediction based on a machine learning algorithm.

The disclosure is also directed to a method including collecting images of an object captured by a camera, storing the captured images in a historical database comprising previous images of the object, dividing the captured images into one or more sectors, identifying a defect in the one or more sectors of the captured image, analyzing the defect in the one or more sectors of the captured images in view of the previous images, and extrapolating the defect in the one or more sectors to determine an overall defect percentage for the object. The method may further include predicting future defects based on the analyzing step.

### BRIEF DESCRIPTION OF THE DRAWINGS

Aspects of the disclosure are directed to systems and methods which are described more fully herein with reference to the accompanying drawings, in which example embodiments are shown. In the following description, for purposes of explanation, numerous specific details are set forth in order to provide an understanding of the various embodiments. However, the instant disclosure may be embodied in many different forms and should not be construed as limited to the example embodiments set forth herein. Where convenient, like numbers refer to like elements.

FIG. 1 is an exemplary block diagram of a system in accordance with the present disclosure;

FIG. 2 is an exemplary illustration of a tank having corrosion dispersed throughout its surface;

FIG. 3 is an exemplary functional block diagram of a UAV control system;

FIG. 4 is an exemplary functional block diagram of a processing architecture in accordance with the present disclosure;

FIG. 5 is a representation of an exemplary schema which may be used in the creation of a database to be used in accordance with the present disclosure;

FIG. 6 is a top view of an exemplary tank showing a grid defining sectors for analysis; and

FIG. 7 is a flow chart of an exemplary method of use of the system.

### DETAILED DESCRIPTION

Overview.

The present disclosure is directed to a system and method for investigation and remediation of water tanks in a novel and nonobvious tank management system. The system includes a rust prediction model based on UAV-captured oblique imagery. The image files captured by UAV operators may be run through a prediction process on and summary details recorded in the tank database. For the purposes of this disclosure, rust and corrosion are used interchangeably and are exemplary only. The present disclosure is applicable to other tank defects such as hail or other weather damage and to inspections of other structures.

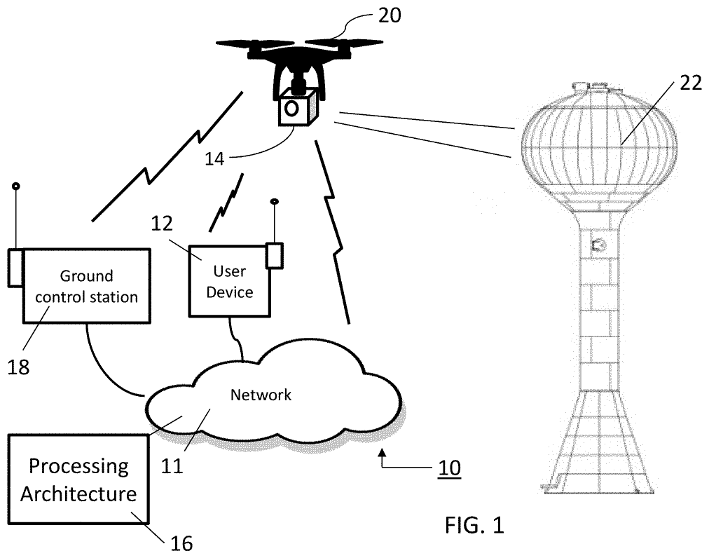

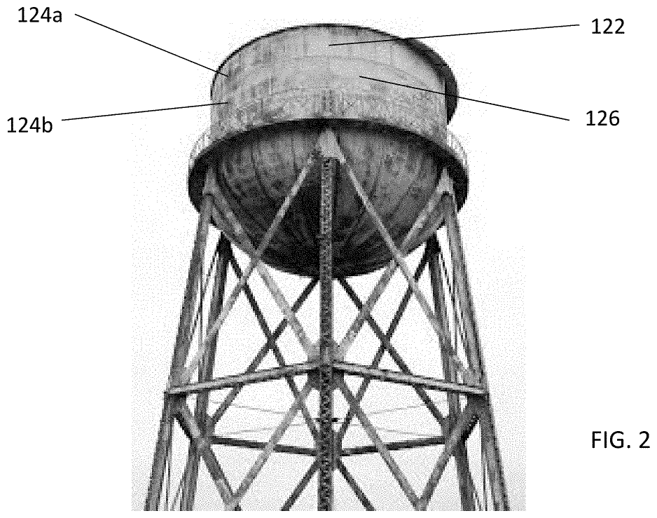

In an aspect, and with reference to FIG. 1, a UAV 24 may be launched in and around the area of one or more storage tanks 22. FIG. 2 shows an exemplary view of storage tank 122 having rust or corrosion portions 124a 124b and painted, non-corroded portions 126. The UAV 20 may be equipped with a camera 24 which may be programmed to capture still or video images of the storage tanks 22. The images taken by the UAV 20 will be stored and processed in accordance with the present disclosure, wherein the processing may include machine learning algorithms in which the images may be compared to historical data to not only observe the current state of the storage tank materials, but also to predict rust or other degradations of the material over time.

In an aspect, machine learning algorithms may be used for image analytics and prediction modeling. For example, open source libraries such as Raster Vision may be used to develop a model for classifying images, with any library chosen relying on coding languages such as TensorFlow to implement and deploy the model In general, the machine learning includes processes such as gathering statistics and metrics for use in processing, creating training chips from a variety of images and labels, training a model, predicting outcomes using trained models on test data, evaluating the model using an F1 score to measure the accuracy and precision of test data predictions, and then, once the model is sufficiently trained, applying that model to the tank images captured by the UAV 20.

The output of such a rust prediction model may provide classification of sections of an image of tank that are predicted to contain rust. From this, it is possible to determine a rudimentary proportion of rust-to-tank sections per image, based on the amount of tank found in the image. The collection of images may comprise images of the entire surface of the tanks or selected images of the tank. In the case where only selected images are captured, the processing may include extrapolation of the data to predict rust over the entire surface area of the tank.

The system and method of the present disclosure may automatically detect portions where paint has chipped down to the primer or bare metal layer or where rust has set in. Other defects may also be automatically detected. The percentage of the surface area containing defects may predict future defects and serve as a guide to maintenance activities such as sandblasting and repainting the tanks. The maintenance schedule may be based on the predicted percentage of defects as compared to the overall surface area of the tanks wherein the predicted percentage of defects is extrapolated from defects found in one or more sectors of the surface of the tank.

In an aspect, a mapping function may be included indicating the location of tanks and which of these tanks are subject to inspection at a given time. In an aspect, external parameters including weather patterns may be collected, consumed and processed to determine and predict the effects of such parameters on corrosion prediction.

Operating Environment.

With reference to FIG. 1, there is shown a system 10 in which the present disclosure may be implemented. The system 10 may include network 11, an input user device—also called user equipment (UE) herein—12, which may, for example, be a smartphone, desktop, laptop or tablet. There may also be a ground control station 16. Each of the user device 12 and ground control station 16 may be in communication with an unmanned aerial vehicle 20 having a camera 14 attached thereto in which such communication is either directly or through network 11. Note that the description herein will refer to tanks generically and use the example of a water tank, but the disclosure is equally applicable to other types of tanks including, but not limited to fuel tanks, chemical feed tanks and the like, as well as other structures that would benefit from aerial visual inspection and analysis, including but not limited cell towers, wind mills and other structures

The disclosure is applicable to any type of network 11, including but not limited to any type of wireless communication network, including 3G, fourth generation (4G)/LTE, fifth generation (5G), and any other wireless communication network, a public switched telephone network (“PSTN”), a wide-area local area network (“WLAN”) and may, for example include virtual private network (“VPN”) access points, Wi-Fi access points, and any other access points capable of interfacing with the network 11. It will be understood by those skilled in the art that while the network 11 may comprise the afore-mentioned networks, a combination of one or more communication networks may be used. Each of the input devices 12 and ground control station 18 (described in more detail below) may be in communication with processing architecture 16 through network 11.

The UE 12 may, for example, be a smartphone, tablet or personal computer configured with an operating system which may, for example, be one of Apple's iOS, Google's Android, Microsoft Windows Mobile, or any other smartphone operating system or computer operating system or versions thereof. The UE 12 may control user input functions, including, but not limited to, selection and control of inputs to system 10 and receipt and display of outputs from system 10. To communicate with the network 11, the UE 12 may have a communication interface for a wireless or wired communication system, which may, for example, be Wi-Fi, Bluetooth®, 3G, 46 LTE, and 5G, WiFi, LAN, WiLan or any other wireless communication system. The UE 16 may be in communication with an application server 18 through any of the above-identified systems.

The functionality embedded and described in the present disclosure may reside either on the UE 11, the processing architecture 16. the ground control station 18 or a combination thereof. Any such designation of functionality between such components may be a design choice or based on user experience, performance, cost, or any other factors.

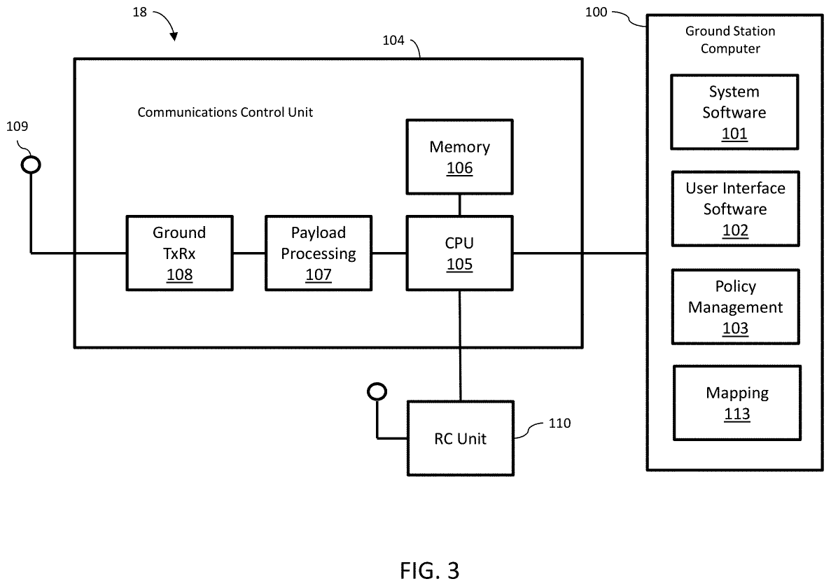

An exemplary configuration of a ground control station 18 is shown in FIG. 3. Generally, the ground control station 18 may comprise a ground station computer 100, a communications control unit 104, and a radio control unit 110. In an embodiment, the radio control unit 110 may be configured to communicate with UAV 20 through network 11.

The ground station computer 100 may be any general-purpose computer or server specially programmed to provide the exemplary functionality set forth herein. There may, for example, be both system software 101 and user interface software 102 to provide user control of the ground control station 18. There may also be a policy management function 103 which may, for example, provide prioritization for commands or authorization credentials for issuing such commands from the ground control station and determining the prioritization of tasks when in communication with the UAV 20. There may also be a mapping function 113 which provides access to and creation of 2-dimensional or 3-dimensional maps of the geographic area that the UAV 20 may be programmed for flight and which may, for example, also include the location of tanks or other areas of interest.

The communications control unit 104 may include CPU 105, memory 106, payload processing 107 and a transceiver function 108. With respect to payload processing 107, such processing may include, for example, a control program for directing the UAV 20 both pre-flight and in-flight to perform various functions, including but not limited to flight path corrections and updates, activation of camera 14, emergency alerts and maneuvers, and the like. It will be understood by those skilled in the art that the exemplary functionality described with respect to the communications control unit 104, ground station computer 100 and the radio control unit 110 may be integrated into one shared computer or the functionality divided into two or more computers or components thereof.

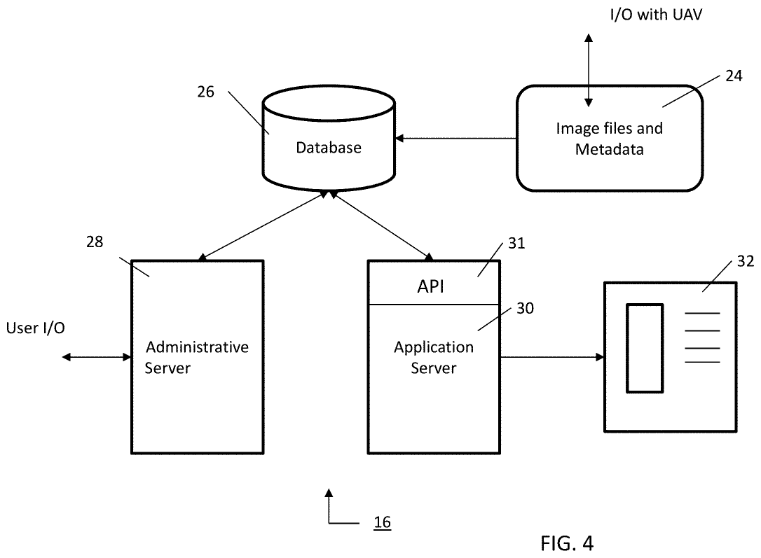

With reference to FIG. 4, there is shown an exemplary functional block diagram of a processing architecture 16. The processing architecture 16 may include an administrative server 28 which may, for example, provide overall control of the UAV 20 image collection processes. This process may include, for example, flight plans and controls, UAV 20 maintenance records and schedules, user applications including user authorization levels, batch processing scheduling, and other administrative functions associated with the image processing and prediction functions.

User Interfaces.

The processing architecture 16 may include a user interface 32 for accessing the processed images and inputting control commands. The user interface 32 may be web-based and include programming based on HTML, CSS and/or JavaScript. The user interface 32 may show various information, layouts and workflows that are accessible from a web browser and which may be configurable by a user. The user interface 32 may include a tank dashboard comprising tanks and tank detail pages allowing maintenance, checklist and flight imagery to be displayed. The user interface 32 may include an option for adding new tanks, sites and new or updated site checklists.

Image Collection.

The processing architecture 16 may include a collection function 24 for image data and metadata associated with the image data, the collection function 24 being in communication with a UAV 20. The collection function 24 may interface with the UAV 20 through network 11 and may include a protocol whereby the image data received is pushed from the UAV 20 to the collection function 24 continuously or periodically, or alternatively, the image data may be requested by the collection function 24. In an aspect, the processing architecture 16 may automatically ingest images.

The image files may be any type of files captured by the camera 14 of UAV 20, including raw image data or processed image data. The image files may be in one or more raster formats such as JPEG, TIFF, BNP or any other raster formats, vector formats such as CGM, SVG, or any other vector formats, or compound formats that contain both pixel data and vector data. The image data may be compressed for transport across network 11 in accordance with standard compression/decompression methods. The metadata associated with the image files may include, but is not limited to, image identification data, geographic data, time of day data, tank information data, tank sector identification data, and other types of metadata.

The collection function 24 may interface with database 26 wherein the image files and associated metadata is stored for further processing. The database 26 may be local, remote or housed in a cloud configuration. Data in the database 26 may be encrypted. The database 26 may be any type of database and may, for example, be created using PostgreSQL. The schema set forth below may have one or more tables and such tables need not be static in either content or quantity. The schema may differ based on the type of application being run. The database 26 may be queried from various open source or proprietary applications such as Python deployed on a Linux runtime environment.

Tank Database.

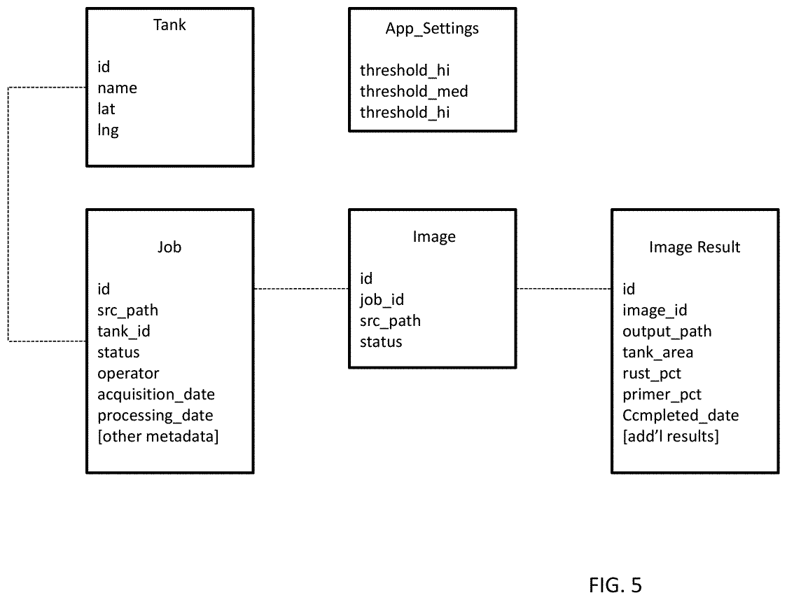

With reference to FIG. 5, there is shown a tank database 26 schema which may capture a significant amount of detail regarding tanks and tank history. The database 26 may be in any type of relational database such as Microsoft Access or a flattened database including an enterprise database instance. The database 26 may be locally stored and managed or be stored and managed in a storage cloud environment. The schema of the database 26 may include the following exemplary schema set forth below and illustrated in FIG. 5:

Tank attributes, which may, for example, include name, size, age, type, risk scores, and other types of attributes;

Baseline maintenance records, which may, for example, include a set of relations describing maintenance histories;

Site visit checklist records, which may, for example, include a set of relations describing the checklist filled out by visitors to a tank during a UAV flight session;

UAV flight history, which may, for example, include the pilot, date, location of flight images, initial rust predictions and other flight data; and

Outputs of the prediction processes, including summary details of each of the respective tanks in the database.

Application Programming Interface.

In an embodiment, there may be an application programming interface (API) 31 which may, for example, be a representational state transfer (“REST”) API. The API 31 may expose read/write operations to the database 26 and which may, for example, be accessible by programs running on application server 32.

The API 31 may be developed for a proprietary or a web-based framework such as Python or Django and delivered as a Docker image with http ports open. The API 31 may include functional processes including, but not limited to, retrieval of a list of tanks with minimal identifying information, retrieval of individual tank data and metadata, retrieval of images captured by the UAV 20, writing of data for existing tank site-checklists and other data I/O functions. The input and output images may be copied or stored in a location which made available to the API service or directly served using an HTTP interface.

Application Server.

The processing architecture 16 may include an application server 32 in communication with API 31 and user interface 32. The application server may include pre-processing algorithms, machine learning algorithms, and post-processing algorithms. Pre-processing algorithms may include increased image resolution, quality assessment of images, and other pre-processing functions. Post-processing may include resizing or adjusting the quality of the images to be optimized for web delivery. If optimized versions are not available, raw imagery may be displayed.

The machine learning starts with a specific type of deep neural network known as a residual network. A model built upon a residual learning framework may subtract every feature learned through each iteration of the network through multiple iterations in order to reduce the problem of degrading accuracy within a typical deep learning neural network. There are many variants of a residual learning network and may be known non-exclusively as ResNet50, ResNet101, or ResNet152. As more images are run through the model, the accuracy of the image classification outputs improves and updates the model in a form of training known as a supervised model. The machine-learning algorithms may start with the use of supervised models. The algorithms may include processes such as gathering statistics and metrics for use in processing, creating training chips from a variety of images and metadata, training a model, predicting outcomes using trained models on test data, evaluating the model using an F1 score to measure the accuracy and precision of test data predictions, and then, once the model is sufficiently trained, applying that prediction model to the current and future tank images. The machine-learning algorithms may include one or more of descriptive analytics, diagnostic analytics, predictive analytics, and predictive analytics. Descriptive analytics may be used to generate reports based on the raw images collected by the UAV 20. In that way, a simple visual inspection of the images may show corrosion or other damaged areas on the tanks. Diagnostic analytics may include an analysis of the current image data captured by the UAV 20 compared to the analysis of previously captured image data to derive a “closeness” or similarity description of the current image data to historical image data. By analyzing the rate of change, predictions of future corrosion may be made. Predictive analytics may be used to predict the future corrosion of the tank based on the accumulated historical data and artificial intelligence functions resident in the application server 32, such as exponential down-weighting in which older data is weighted less than newer data. In this manner, the predictive analytics may determine the speed at which two adjacent sectors containing rust may intersect to create a larger rust area. The prescriptive analytics function may also include deep learning functionality in which a cascade of processing layers may be analyzed layer by layer. Other deep learning algorithms such as predictive linear regression (PLR) algorithms logistic regression (LR) which may incorporate nearest-neighbor predictive algorithms. Other predictive analytics may include continuous variable machine logic (CVML), singular value decomposition (SVD), AI-based principal component analysis (PCA). It will be understood that any of the aforementioned machine learning and AI algorithms are exemplary only.

Sample Use Case and Method of Operation.

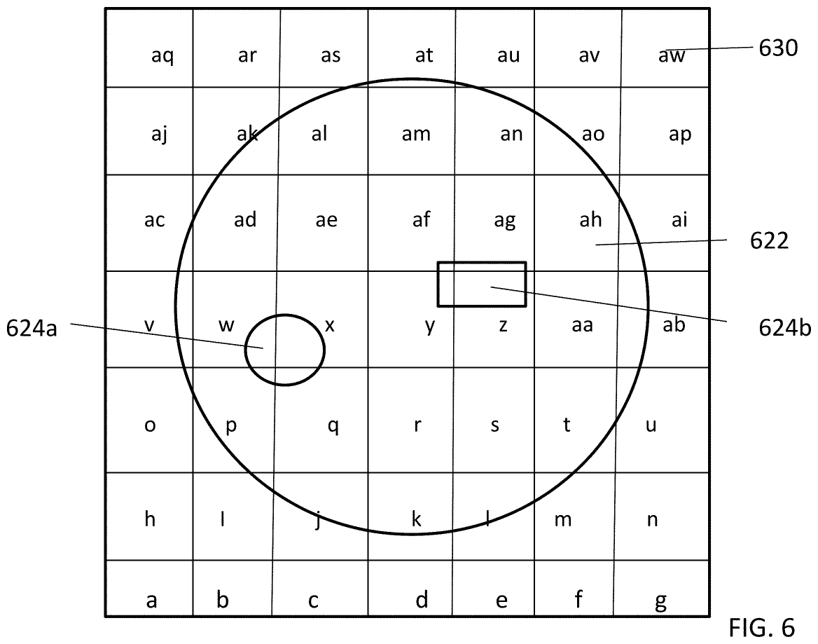

With reference to FIG. 6, there is shown an aerial view of tank 622 showing a circular rust spot 624a and a rectangular rust spot 624b. The image in FIG. 6 is shown with an overlay 630 which in this example, is divided into sectors forming a 7×7 matrix which are labeled “a” through “aw” as shown. Rust spot 624 a covers portions of sectors “w”, “x”, “p”, and “q” while rust spot 624b may be found in portions of sectors “y”, “z”, “af” and “ag”.

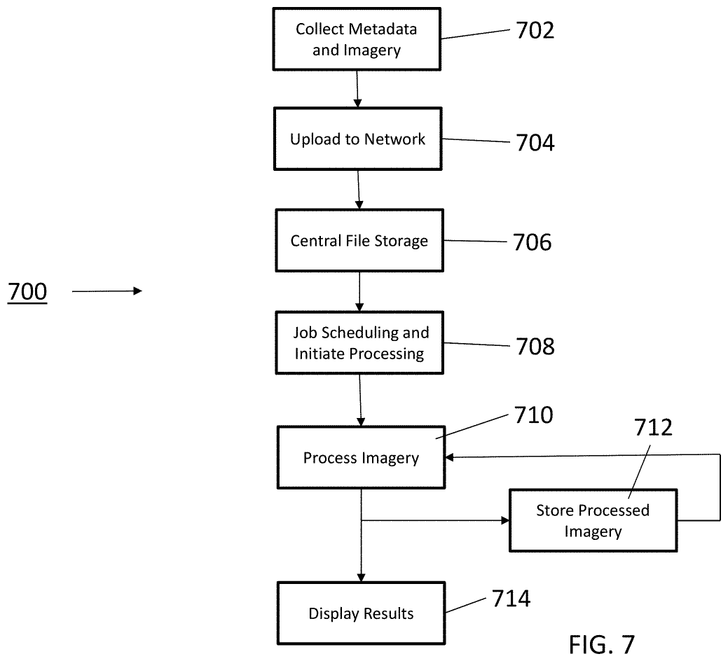

During a mission, the UAV 20 may have an hour-long flight and may take approximately one hundred high quality images using camera 24. In an aspect, exemplary process flow 700 shown in FIG. 7 may be implemented to determine the percentage of rust on a tank 622 and predict future corrosion. At 702, the UAV 20 will collect metadata and imagery using camera 24. The imagery and metadata may be uploaded through network 11 to be processed by the processing architecture 16 at 704. At 706, the imagery and metadata may be stored in the database 26. At 708, the processing job is scheduled, and processing is initiated. The scheduling may be periodic or near real time to coincide with the imagery collection. At 710, the images are processed using application server 30 in accordance with the processing functionality described above. At 712, the processed imagery is stored in database 26 for future use in the machine learning processes and the results are displayed at 714.

The output of the rust prediction model does not need to account for area calculations based on true area of the tank, but instead, may provide classification of sectors of an image of tank that are predicted to contain rust. From this, a rudimentary proportion of rust-to-tank sections per image, based on the amount of tank found in the image, may be calculated. Moreover, images may simply be compared to images from previous missions to show the progression of corrosion and the rate thereof.

Software, Hardware and Systems.

While examples of a system in which data can be processed and managed have been described in connection with various computing devices/processors, the underlying concepts may be applied to any computing device, processor, or system capable of facilitating a computer-based system for providing the functionality described herein. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, Compact Disc-Read-Only Memory devices (CD-ROMs), Digital Versatile Discs, or, Digital Video Discs (DVDs), hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for advanced image processing. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with a system as described herein also may be practiced via communications embodied in the form of program code that is transmitted over some transmission medium, such as over electrical wiring or cabling, through fiber optics, or via any other form of transmission, over the air (OTA), or firmware over the air (FOTA), wherein, when the program code is received and loaded into and executed by a machine, such as an Erasable Programmable Read-Only Memory (EPROM), a gate array, a programmable logic device (PLD), a client computer, or the like, the machine becomes an device for implementing image processing functionality as described herein. When implemented on a general-purpose processor, the program code combines with the processor to provide a unique device that operates to invoke the functionality of a system.

It will be apparent to those skilled in the art that various modifications and variations may be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

The systems and methods of the present disclosure have been described in relation to the predicting rust or other degeneration of water storage tanks. However, the scope of the disclosure extends beyond water tanks and may, for example, include a system and method to evaluate and predict the state and maintenance of other systems in which visual inspections are difficult or expensive, including but not limited to wind mill farms, boilers, manufacturing equipment, oil processing platforms and equipment, and other structures and applications which may benefit from the present disclosure.

The disclosure has been described in connection with a UAV. The system and methods of the present disclosure are not limited thereby but may be implemented on any images and metadata captured by a video or still camera regardless of where that camera is mounted or supported. The camera may be still mounted or mounted on a moveable platform, including a ground robot, a helicopter, an airplane or any other moveable platform. The system may have multiple cameras capturing images from various angles or at various resolutions. Cameras may be mounted on tanks or other objects of interest. All the afore-mentioned camera configurations are within the scope of the present disclosure.

The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A system comprising:
a processor;
an input/output interface connected to the processor; and
memory coupled to the processor, the memory storing executable instructions that cause the processor to effectuate operations comprising:
collecting, by the processor, surface images of an object captured by a camera;
storing, by the processor, the captured surface images in a historical database comprising previous images of the object;
dividing, by the processor, the captured surface images into one or more sectors;
identifying, by the processor, a defect in the one or more sectors of the captured surface image;
analyzing, by the processor, the defect in the one or more sectors of the captured surface images in view of the previous images;
predicting, by the processor, future defects based on the analyzing step.

2. The system in claim 1 wherein the analyzing step includes determining the percentage of defects in the object relative to a total surface area of the object.

3. The system of claim 2 wherein the percentage of defects is extrapolated by an amount of a defect identified in the in one or more sectors.

4. The system of claim 1 wherein the operations further comprise scheduling remedial actions based on the predicting step.

5. The system of claim 1 wherein the operations further comprise correlating, by the processor, the one or more sectors of the captured images with corresponding sectors of the previous images and the analyzing step analyzes the one or more sectors in view of the correlating sectors.

6. The system of claim 1 wherein the historical database also includes images and metadata of a plurality of other similar objects and wherein the operations further include creating a model using the plurality of other similar objects and wherein the analyzing step analyzes the captured surface images in view of the model.

7. The system of claim 6 wherein the camera is mounted on an unmanned aerial vehicle (UAV).

8. The system of claim 7 wherein the object is a tank.

9. The system of claim 8 wherein the tank is one of a water tank, a fuel tank and a chemical feed tank.

10. The system of claim 1 wherein the camera is mounted on an unmanned aerial vehicle and the object is a water tank.

11. The system of claim 10 wherein the historical database also includes images and metadata of a plurality of other water tanks and wherein the operations further include creating a model using the plurality of other water tanks and wherein the analyzing step analyzes the captured surface images in view of the model.

12. The system of claim 1 wherein the analyzing step includes generating a prediction based on a machine learning algorithm.

13. A system comprising:
An input port configured to receive current image files and metadata from a camera;
A database connected to the input port for storing the current image files and metadata, the database also containing historical image files and metadata;
An application server connected to the database through an application programming interface, wherein the application server is configured to process the current image files and metadata by dividing an image into a plurality of sectors, identifying a defect in the one or more sectors, analyzing the defect in the one or more sectors of the historical image files and predicting future defects based on the analyze step.

14. The system of claim 13 wherein the historical image files are divided into sectors corresponding to the one more sectors.

15. The system of claim 13 wherein the analyzing step calculates a percentage of the defect in the one or more sectors to estimate a total percentage of defects for an object.

16. The system of claim 15 wherein the object is a tank.

17. The system of claim 13 wherein the camera is mounted on an unmanned aerial vehicle and the predicting step includes generating a prediction based on a machine learning algorithm.

18. The system of claim 13 wherein the predicting step includes generating a prediction based on a machine learning algorithm.

19. A method comprising:
collecting images of an object captured by a camera;
storing the captured images in a historical database comprising previous images of the object;
dividing the captured surface images into one or more sectors;
identifying a defect in the one or more sectors of the captured image;
analyzing the defect in the one or more sectors of the captured images in view of the previous images;
extrapolating the defect in the one or more sectors to determine an overall defect percentage for the object.

20. The method of claim 19 further comprising predicting future defects based on the analyzing step.
